(19) United States
(12) Patent Application Publication
(10) Pub. No.: US 2026/0239416 A1
(43) Pub. Date: Aug. 13, 2026

(54) CONTENTION WINDOW ADJUSTMENT FOR SIDELINK COMMUNICATION

(71) Applicant: QUALCOMM Incorporated, San Diego, CA (US)

(72) Inventors: Chih-Hao LIU, San Diego, CA (US); Xiaoxia ZHANG, San Diego, CA (US); Jing SUN, San Diego, CA (US); Giovanni CHISCI, San Diego, CA (US); Shaozhen GUO, Beijing (CN)

(21) Appl. No.: 19/153,750

(22) PCT Filed: Apr. 5, 2023
(86) PCT No.: PCT/CN2023/086353

§ 371 Date: Aug. 5, 2025

(51) Int. Cl. H04W 74/0808; H04L 1/1829; H04W 92/18

(52) U.S. Cl. CPC H04W 74/0808; H04L 1/1829; H04W 92/18

(57) ABSTRACT

Various aspects of the present disclosure generally relate to wireless communication. In some aspects, a user equipment (UE) may transmit, during a channel occupancy time (COT) on a sidelink, a first sidelink transmission starting at a second starting symbol candidate that occurs after a first starting symbol candidate that occurs at a beginning of a first slot in the COT. The UE may transmit, during the COT on the sidelink, a second sidelink transmission that spans a duration of a second slot in the COT that occurs after the first slot. The UE may determine a contention window adjustment based at least in part on hybrid automatic repeat request (HARQ) feedback received for the second slot. Numerous other aspects are described.

### FIELD OF THE DISCLOSURE

Aspects of the present disclosure generally relate to wireless communication and to techniques and apparatuses for contention window adjustment for sidelink communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, during a channel occupancy time (COT) on a sidelink, a first sidelink transmission starting at a second starting symbol candidate that occurs after a first starting symbol candidate that occurs at a beginning of a first slot in the COT. The method may include transmitting, during the COT on the sidelink, a second sidelink transmission that spans a duration of a second slot in the COT that occurs after the first slot. The method may include determining a contention window adjustment based at least in part on hybrid automatic repeat request (HARQ) feedback received for the second slot.

Some aspects described herein relate to a method of wireless communication performed by a UE. The method may include transmitting, during a COT on a sidelink, a first sidelink transmission starting at a second starting symbol candidate that occurs after a first starting symbol candidate that occurs at a beginning of a first slot in the COT. The method may include transmitting, during the COT on the sidelink, a second sidelink transmission that spans a duration of a second slot in the COT that occurs after the first slot. The method may include determining a contention window adjustment based at least in part on, first HARQ feedback received for the first slot, or second HARQ feedback received for the second slot.

Some aspects described herein relate to a method of wireless communication performed by a UE. The method may include transmitting, during a COT on a sidelink, a first sidelink transmission starting at a second starting symbol candidate that occurs after a first starting symbol candidate that occurs at a beginning of a first slot in the COT. The method may include transmitting, during the COT on the sidelink, a second sidelink transmission that spans a duration of a second slot in the COT that occurs after the first slot. The method may include determining a contention window adjustment based at least in part on, first HARQ feedback received for the first slot, and second HARQ feedback received for the second slot.

Some aspects described herein relate to a UE for wireless communication. The user equipment may include a memory and one or more processors coupled to the memory. The one or more processors may be configured to transmit, during a COT on a sidelink, a first sidelink transmission starting at a second starting symbol candidate that occurs after a first starting symbol candidate that occurs at a beginning of a first slot in the COT. The one or more processors may be configured to transmit, during the COT on the sidelink, a second sidelink transmission that spans a duration of a second slot in the COT that occurs after the first slot. The one or more processors may be configured to determine a contention window adjustment based at least in part on HARQ feedback received for the second slot.

Some aspects described herein relate to a UE for wireless communication. The UE may include a memory and one or more processors coupled to the memory. The one or more processors may be configured to transmit, during a COT on a sidelink, a first sidelink transmission starting at a second starting symbol candidate that occurs after a first starting symbol candidate that occurs at a beginning of a first slot in the COT. The one or more processors may be configured to transmit, during the COT on the sidelink, a second sidelink transmission that spans a duration of a second slot in the COT that occurs after the first slot. The one or more processors may be configured to determine a contention window adjustment based at least in part on, first HARQ feedback received for the first slot, or second HARQ feedback received for the second slot.

Some aspects described herein relate to a UE for wireless communication. The UE may include a memory and one or more processors coupled to the memory. The one or more processors may be configured to transmit, during a COT on a sidelink, a first sidelink transmission starting at a second starting symbol candidate that occurs after a first starting symbol candidate that occurs at a beginning of a first slot in the COT. The one or more processors may be configured to transmit, during the COT on the sidelink, a second sidelink transmission that spans a duration of a second slot in the COT that occurs after the first slot. The one or more processors may be configured to determine a contention window adjustment based at least in part on, first HARQ feedback received for the first slot, and second HARQ feedback received for the second slot.

Some aspects described herein relate to a non-transitory computer-readable medium that stores a set of instructions for wireless communication by a UE. The set of instructions, when executed by one or more processors of the UE, may cause the UE to transmit, during a COT on a sidelink, a first sidelink transmission starting at a second starting symbol candidate that occurs after a first starting symbol candidate that occurs at a beginning of a first slot in the COT. The set of instructions, when executed by one or more processors of the UE, may cause the UE to transmit, during the COT on the sidelink, a second sidelink transmission that spans a duration of a second slot in the COT that occurs after the first slot. The set of instructions, when executed by one or more processors of the UE, may cause the UE to determine a contention window adjustment based at least in part on HARQ feedback received for the second slot.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to transmit, during a COT on a sidelink, a first sidelink transmission starting at a second starting symbol candidate that occurs after a first starting symbol candidate that occurs at a beginning of a first slot in the COT. The set of instructions, when executed by one or more processors of the one or more instructions that, when executed by one or more processors of an UE, may cause the one or more instructions that, when executed by one or more processors of an UE to transmit, during the COT on the sidelink, a second sidelink transmission that spans a duration of a second slot in the COT that occurs after the first slot. The set of instructions, when executed by one or more processors of the one or more instructions that, when executed by one or more processors of an UE, may cause the one or more instructions that, when executed by one or more processors of an UE to determine a contention window adjustment based at least in part on, first HARQ feedback received for the first slot, or second HARQ feedback received for the second slot.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to transmit, during a COT on a sidelink, a first sidelink transmission starting at a second starting symbol candidate that occurs after a first starting symbol candidate that occurs at a beginning of a first slot in the COT. The set of instructions, when executed by one or more processors of the one or more instructions that, when executed by one or more processors of an UE, may cause the one or more instructions that, when executed by one or more processors of an UE to transmit, during the COT on the sidelink, a second sidelink transmission that spans a duration of a second slot in the COT that occurs after the first slot. The set of instructions, when executed by one or more processors of the one or more instructions that, when executed by one or more processors of an UE, may cause the one or more instructions that, when executed by one or more processors of an UE to determine a contention window adjustment based at least in part on, first HARQ feedback received for the first slot, and second HARQ feedback received for the second slot.

Some aspects described herein relate to an apparatus for wireless communication. The apparatus may include means for transmitting, during a COT on a sidelink, a first sidelink transmission starting at a second starting symbol candidate that occurs after a first starting symbol candidate that occurs at a beginning of a first slot in the COT. The apparatus may include means for transmitting, during the COT on the sidelink, a second sidelink transmission that spans a duration of a second slot in the COT that occurs after the first slot. The apparatus may include means for determining a contention window adjustment based at least in part on HARQ feedback received for the second slot.

Some aspects described herein relate to an apparatus for wireless communication. The apparatus may include means for transmitting, during a COT on a sidelink, a first sidelink transmission starting at a second starting symbol candidate that occurs after a first starting symbol candidate that occurs at a beginning of a first slot in the COT. The apparatus may include means for transmitting, during the COT on the sidelink, a second sidelink transmission that spans a duration of a second slot in the COT that occurs after the first slot. The apparatus may include means for determining a contention window adjustment based at least in part on, first HARQ feedback received for the first slot, or second HARQ feedback received for the second slot.

Some aspects described herein relate to an apparatus for wireless communication. The apparatus may include means for transmitting, during a COT on a sidelink, a first sidelink transmission starting at a second starting symbol candidate that occurs after a first starting symbol candidate that occurs at a beginning of a first slot in the COT. The apparatus may include means for transmitting, during the COT on the sidelink, a second sidelink transmission that spans a duration of a second slot in the COT that occurs after the first slot. The apparatus may include means for determining a contention window adjustment based at least in part on, first HARQ feedback received for the first slot, and second HARQ feedback received for the second slot.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of sidelink communication in a shared wireless communication spectrum, in accordance with the present disclosure.

FIGS. 7A and 7B are diagrams illustrating an example of contention window adjustment for sidelink communication, in accordance with the present disclosure.

FIG. 8 is a diagram illustrating an example process performed, for example, by a UE, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

### DETAILED DESCRIPTION

A sidelink resource pool may include one or more resources (e.g., time domain resources, frequency domain resources) on which sidelink transmissions may be transmitted and/or received on a sidelink in a wireless network. In some cases, a sidelink resource pool may be configured with multiple starting symbol candidates at which a user equipment (UE) may start a sidelink transmission. A first starting symbol candidate may occur at the beginning of a slot, and one or more additional starting symbol candidates may occur at a time within the slot. The additional starting symbol candidates may provide the sidelink UE with more options to start a sidelink transmission, which increases the likelihood that the UE will be able to clear a listen before talk (LBT) procedure and transmit on the sidelink during a channel occupancy time (COT).

However, the availability of additional starting symbol candidates within a slot may result in fewer time domain resources (e.g., symbols) in the slot that may be used for a sidelink transmission. For example, a UE may be required to complete a sidelink transmission at a particular ending time, regardless of whether the UE starts the sidelink transmission at a first starting symbol candidate at the beginning of a slot or at an additional starting symbol candidate within the slot, resulting fewer symbols for the sidelink transmission. This may lead to the sidelink transmission being punctured, which may increase the likelihood of the UE receiving a negative acknowledgement (NACK) as the hybrid automatic repeat request (HARQ) feedback for the sidelink transmission.

Moreover, if the sidelink transmission is started at an additional starting symbol candidate within the slot, the nominal symbol duration (also referred to as a configured quantity of reference symbols) that the UE uses for determining a transport block size (TBS) for the sidelink transmission may be different from the actual symbol duration of the sidelink transmission. This may lead to inaccurate encoding of the sidelink transmission, which may further increase the likelihood of a NACK being received as the HARQ feedback for the sidelink transmission.

If the Tx UE receives a NACK for the sidelink transmission, the NACK may result in the UE unnecessarily increasing a size (e.g., a time duration) of contention window for performing the LBT procedure, even though the UE is already capable of clearing the LBT procedure.

In some aspects described herein, a UE may clear an LBT procedure to obtain a COT for transmitting a sidelink communication on a sidelink. If the sidelink resource pool associated with the sidelink transmission is configured with multiple starting symbol candidates (e.g., a first starting symbol candidate that occurs at the beginning of each slot and one or more additional starting symbol candidates that occur within each slot), the UE may start the sidelink transmission at one of the additional starting symbol candidates in a slot. If the COT spans a plurality of slots, the UE may intelligently select which of the slots for which HARQ feedback is to be used to determine a contention window adjustment.

For example, the UE may determine to use the HARQ feedback associated with a first full-slot sidelink transmission in the COT because the first full-slot sidelink transmission may be less likely to be punctured and/or may be more accurately encoded, which may reduce the likelihood of the UE receiving a NACK for the first full-slot sidelink transmission. This may avoid or reduce the likelihood of the UE unnecessarily increasing the size (e.g., the duration) of the contention window.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

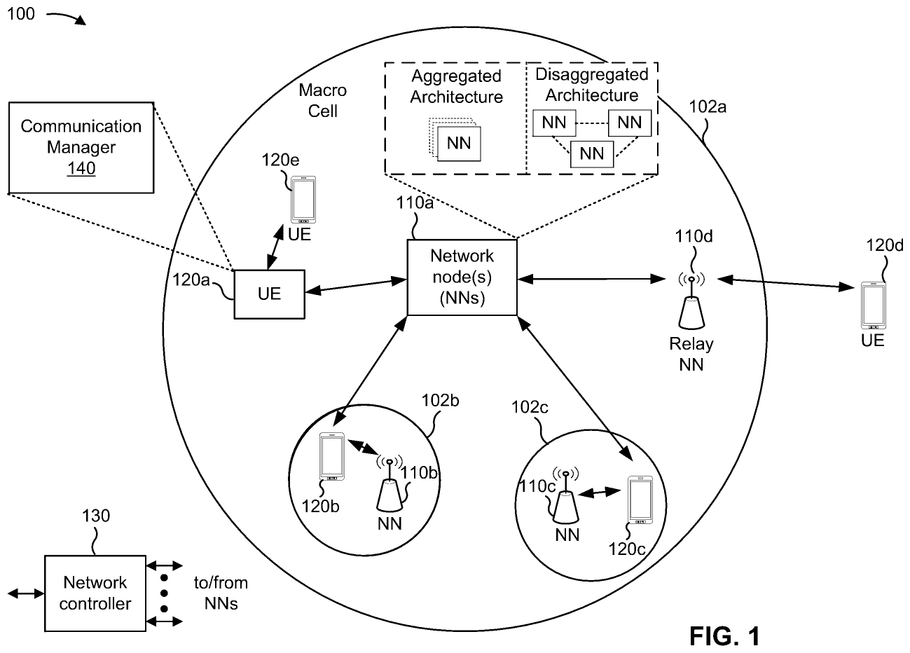

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE 120 may include a communication manager 140. As described in more detail elsewhere herein, the communication manager 140 may transmit, during a COT on a sidelink, a first sidelink transmission starting at a second starting symbol candidate that occurs after a first starting symbol candidate that occurs at a beginning of a first slot in the COT; transmit, during the COT on the sidelink, a second sidelink transmission that spans a duration of a second slot in the COT that occurs after the first slot; and determine a contention window adjustment based at least in part on HARQ feedback received for the second slot. Additionally, or alternatively, the communication manager 140 may perform one or more other operations described herein.

In some aspects, a UE 120 may include a communication manager 140. As described in more detail elsewhere herein, the communication manager 140 may transmit, during a COT on a sidelink, a first sidelink transmission starting at a second starting symbol candidate that occurs after a first starting symbol candidate that occurs at a beginning of a first slot in the COT; transmit, during the COT on the sidelink, a second sidelink transmission that spans a duration of a second slot in the COT that occurs after the first slot; and determine a contention window adjustment based at least in part on first HARQ feedback received for the first slot or second HARQ feedback received for the second slot. Additionally, or alternatively, the communication manager 140 may perform one or more other operations described herein.

In some aspects, a UE 120 may include a communication manager 140. As described in more detail elsewhere herein, the communication manager 140 may transmit, during a COT on a sidelink, a first sidelink transmission starting at a second starting symbol candidate that occurs after a first starting symbol candidate that occurs at a beginning of a first slot in the COT; transmit, during the COT on the sidelink, a second sidelink transmission that spans a duration of a second slot in the COT that occurs after the first slot; and determine a contention window adjustment based at least in part on first HARQ feedback received for the first slot and second HARQ feedback received for the second slot. Additionally, or alternatively, the communication manager 140 may perform one or more other operations described herein.

As indicated above, FIG. 1 is provided as an example. Other examples may differ from what is described with regard to FIG. 1.

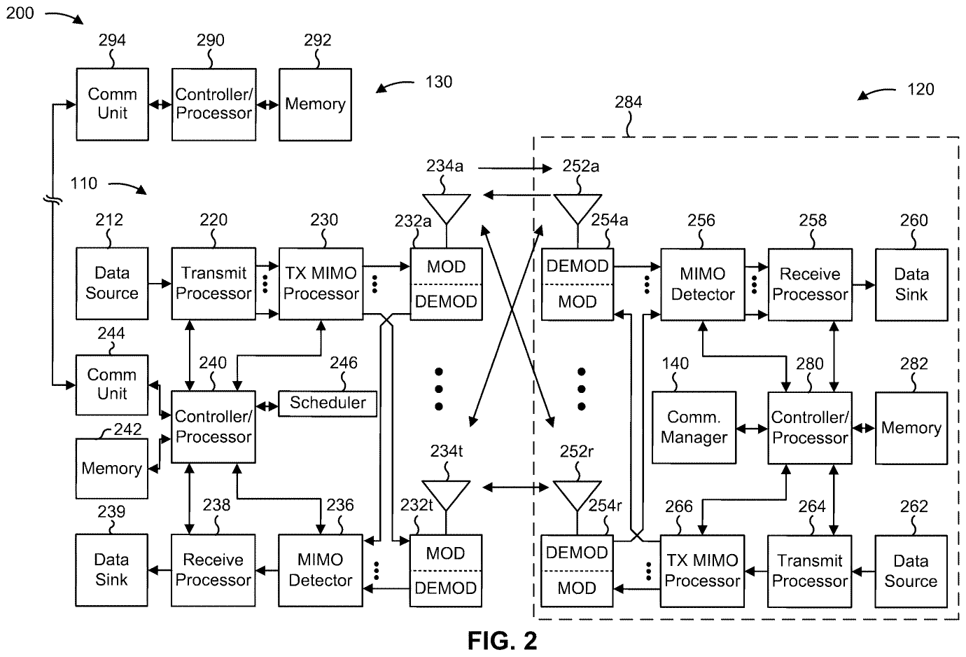

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

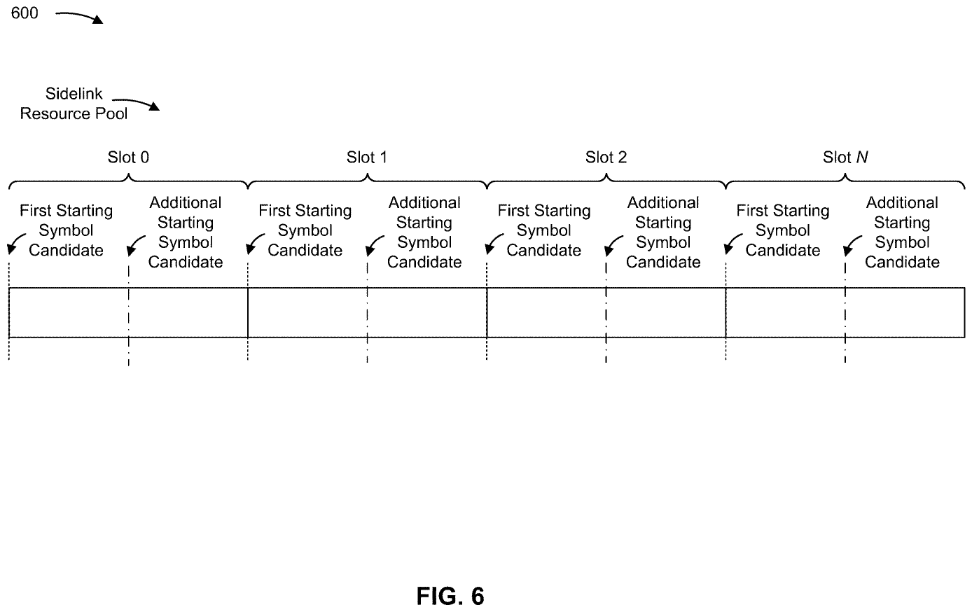

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

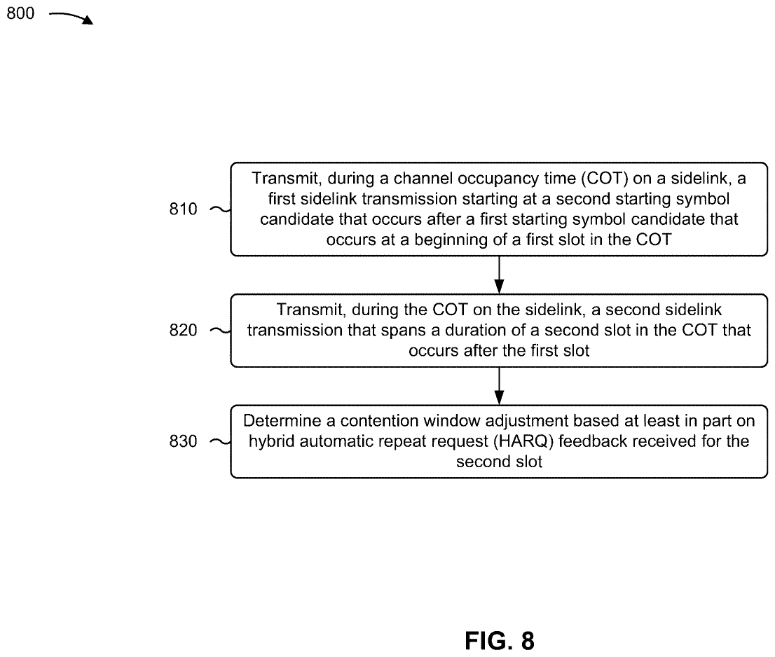

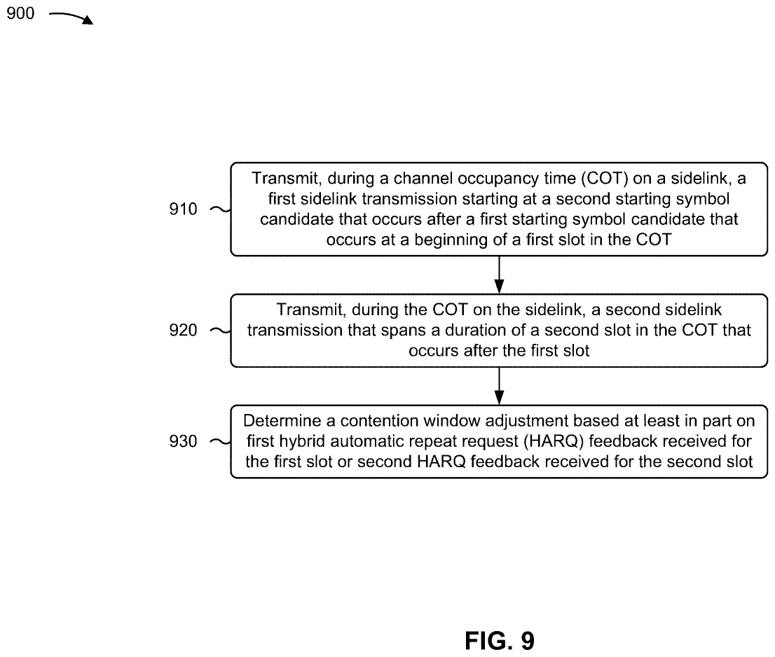

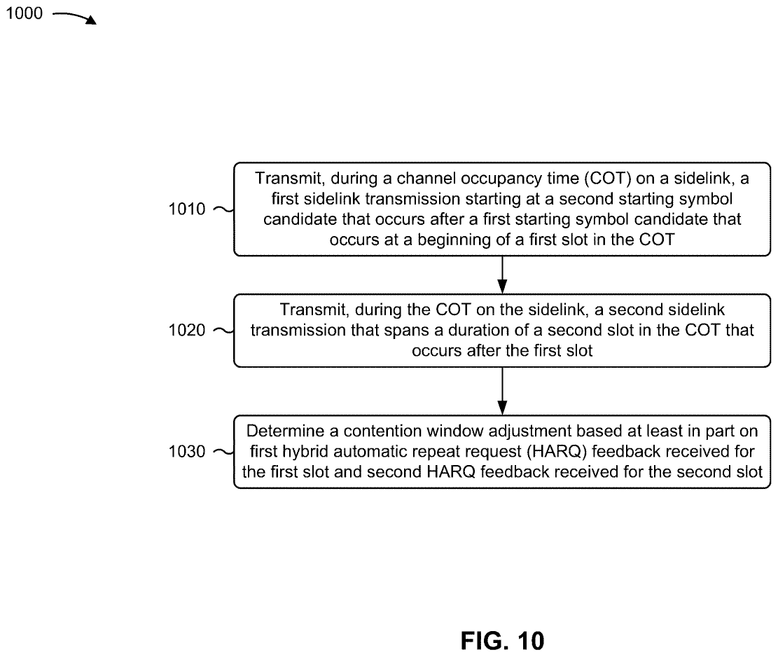

The controller/processor 240 of the network node 110, the controller/processor 280 of the UE 120, and/or any other component(s) of FIG. 2 may perform one or more techniques associated with contention window adjustment for sidelink communication, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for transmitting, during a COT on a sidelink, a first sidelink transmission starting at a second starting symbol candidate that occurs after a first starting symbol candidate that occurs at a beginning of a first slot in the COT; means for transmitting, during the COT on the sidelink, a second sidelink transmission that spans a duration of a second slot in the COT that occurs after the first slot; and/or means for determining a contention window adjustment based at least in part on HARQ feedback received for the second slot. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for transmitting, during a COT on a sidelink, a first sidelink transmission starting at a second starting symbol candidate that occurs after a first starting symbol candidate that occurs at a beginning of a first slot in the COT; means for transmitting, during the COT on the sidelink, a second sidelink transmission that spans a duration of a second slot in the COT that occurs after the first slot; and/or means for determining a contention window adjustment based at least in part on first HARQ feedback received for the first slot or second HARQ feedback received for the second slot. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for transmitting, during a COT on a sidelink, a first sidelink transmission starting at a second starting symbol candidate that occurs after a first starting symbol candidate that occurs at a beginning of a first slot in the COT; means for transmitting, during the COT on the sidelink, a second sidelink transmission that spans a duration of a second slot in the COT that occurs after the first slot; and/or means for determining a contention window adjustment based at least in part on first HARQ feedback received for the first slot and second HARQ feedback received for the second slot. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

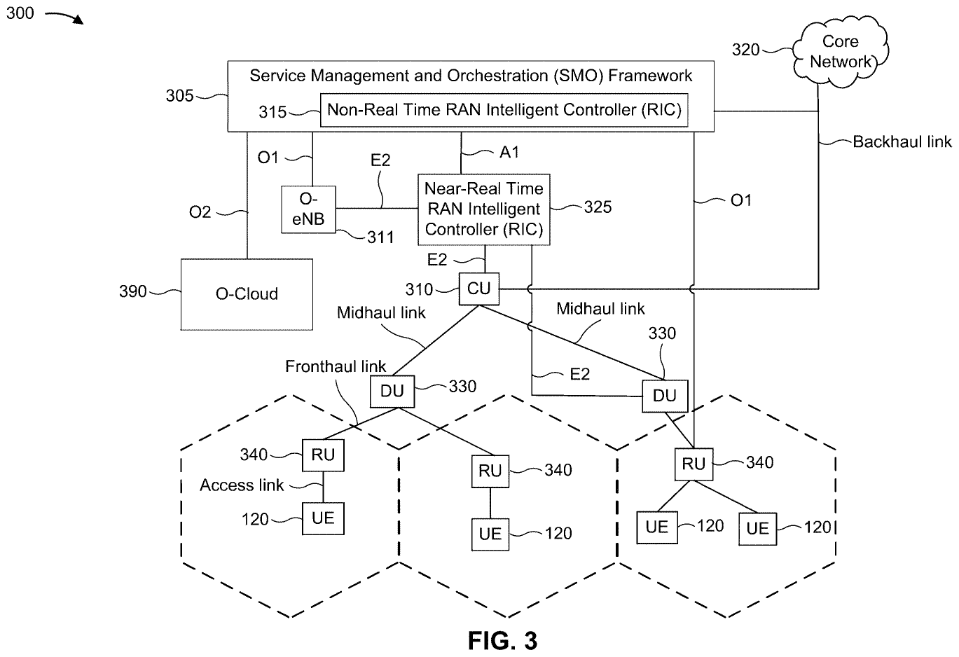

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiplr RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

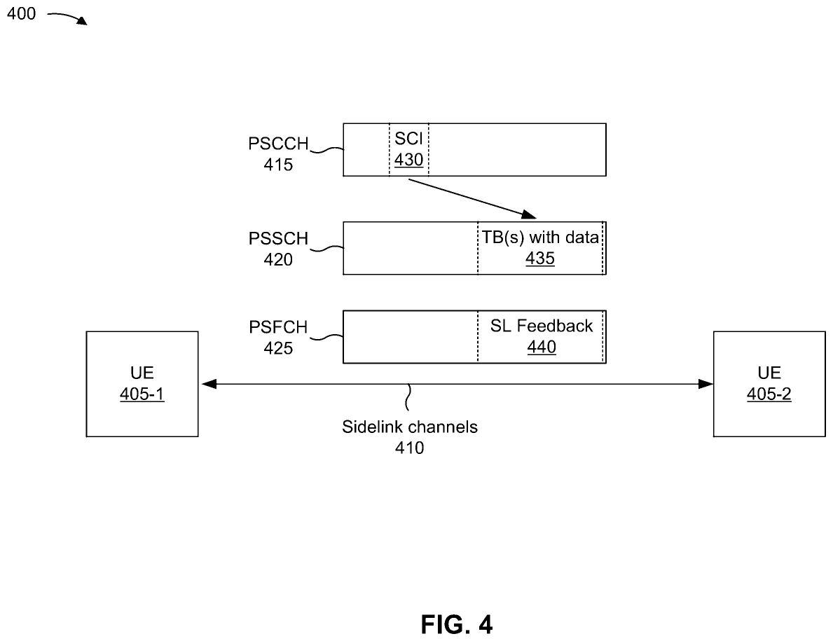

FIG. 4 is a diagram illustrating an example 400 of sidelink communications, in accordance with the present disclosure.

As shown in FIG. 4, a first UE 405-1 (e.g., a UE 120) may communicate with a second UE 405-2 (e.g., another UE 120) (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as HARQ feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

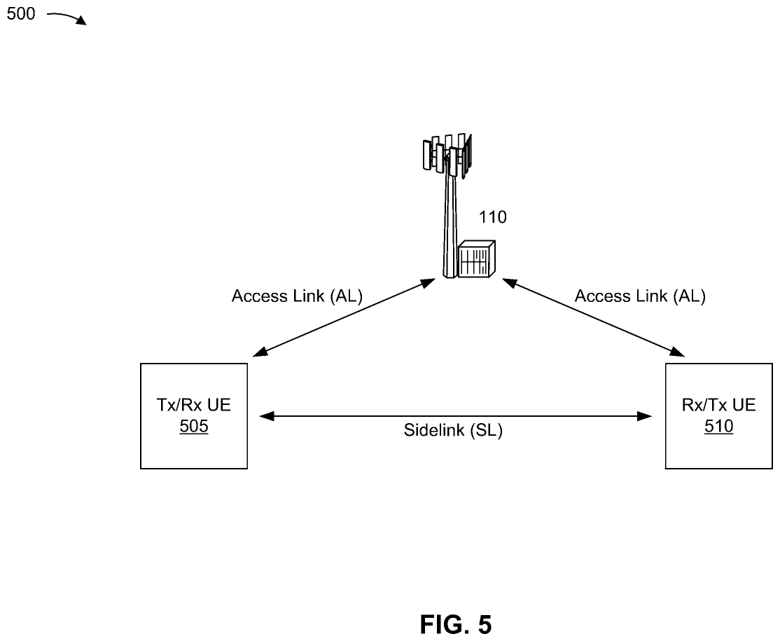

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

FIG. 6 is a diagram illustrating an example 600 of sidelink communication in a shared wireless communication spectrum, in accordance with the present disclosure.

In a wireless communication spectrum, all or a portion of a frequency band may be shared between sidelink UEs in a wireless network and entities referred to as fixed service incumbents of the frequency band. When operating a portion of a wireless network (e.g., the wireless network 100) in a shared wireless communication spectrum (e.g., using licensed assisted access (LAA), enhanced LAA (eLAA), and/or NR unlicensed (NR-U), among other examples), procedures may be implemented to ensure fair coexistence with incumbent (e.g., WLAN) devices that may be operating in the shared wireless communication spectrum.

For example, prior to gaining access to and/or transmitting over a frequency band in a shared wireless communication spectrum, a UE 120 (or a UE 405, a UE 120, a Tx/Rx UE 505, and/or an Rx/Tx UE 510) may perform an LBT procedure to contend for access to the frequency band in the shared wireless communication spectrum. The LBT procedure may include a clear channel assessment (CCA) procedure to determine whether the frequency band is available (e.g., unoccupied by other transmitters). In particular, a UE 120 may perform a CCA procedure to detect an energy level on the frequency band and determine whether the energy level satisfies (e.g., is less than or equal to) an energy detection threshold for a threshold duration of time. When the energy level satisfies (e.g., is below) the energy detection threshold for the threshold duration of time, the LBT procedure is deemed to be successful (referred to as clearing the LBT procedure), and the transmitting device may gain access to the unlicensed channel for a duration referred to as a COT. During the channel occupancy time, the UE 120 can perform one or more sidelink transmissions without having to perform any additional LBT operations. However, if the energy level fails to satisfy (e.g., equals or exceeds) the energy detection threshold, the LBT procedure fails and contention to access the unlicensed channel by the transmitting device is unsuccessful.

In cases where the LBT procedure fails due to the CCA procedure resulting in a determination that the frequency band is unavailable (e.g., because the energy level detected on the frequency band indicates that another device is already using the channel), the CCA procedure may be performed again at a later time. In environments in which the transmitting device may be starved of access to a frequency band (e.g., due to WLAN activity or transmissions by other devices), the UE 120 may extend the window (referred to as a contention window) in which the UE 120 can perform the CCA procedure. Increasing the size of the contention window (e.g., increasing the time duration) provides the UE 120 with a longer time duration in which the UE 120 can try to successfully perform a CCA procedure to clear the LBT procedure.

As shown in FIG. 6, a sidelink resource pool may be allocated for sidelink communication between a plurality of sidelink UEs (e.g., a UE 120, a UE 405, a UE 120, a Tx/Rx UE 505, and/or an Rx/Tx UE 510). The sidelink resource pool may include one or more resources (e.g., time domain resources, frequency domain resources) on which sidelink transmissions may be transmitted and/or received on the sidelink in a wireless network (e.g., the wireless network 100). The time domain resources included in the sidelink resource pool may include a plurality or slots (e.g., Slot 0 through Slot N, among other examples). Each slot may include a plurality of symbols. The frequency domain resources included in the sidelink resource pool may include a frequency band (or one or more frequency domain resources included therein, such as resource blocks, resource elements, channels, subcarriers, and/or subchannels, among other examples) that is included in a shared wireless communication spectrum.

The sidelink resource pool may be configured with a plurality of starting symbol candidates at which a sidelink UE may start a sidelink transmission on the sidelink. Each slot may include a first starting symbol candidate and one or more additional starting symbol candidates may occur at a time within each slot after the first starting symbol candidate. The additional starting symbol candidates may provide the sidelink UE with more options to start a sidelink transmission, which increases the likelihood that the sidelink UE will be able to clear an LBT procedure and transmit on the sidelink during a channel occupancy time.

In some aspects, the first starting symbol candidate of a slot may occur at the beginning of the slot (e.g., corresponding to Symbol #0 of each slot). In some aspects, the first starting symbol candidate of a slot may be configured to occur after the Symbol #0 of the slot. For example, the first starting symbol candidate of a slot may be configured to be Symbol #1, Symbol #2, Symbol #3, Symbol #4, Symbol #5, Symbol #6, or another symbol in the slot. In some aspects, the location of a first starting symbol candidate in a slot in the sidelink resource pool may be configured per bandwidth part of the sidelink. In some aspects, the sidelink UEs may use Symbol #0 as the first starting symbol candidate if the location of the first starting symbol candidate is not otherwise indicated in a configuration.

An additional starting symbol candidate in a slot may occur after the first starting symbol candidate of the slot. For example, an additional starting symbol candidate of a slot may be configured to occur after the Symbol #0 of the slot. In some aspects, an additional starting symbol candidate of a slot may be configured to be Symbol #3, Symbol #4, Symbol #5, Symbol #6, Symbol #7, or another symbol in the slot. In some aspects, an additional starting symbol candidate of a slot may be configured to occur early enough in a slot to provide a particular quantity of symbols (e.g., at least 6 symbols or another quantity) for a sidelink transmission if the sidelink transmission were started at the additional starting symbol candidate.

As indicated above, FIG. 6 is provided as an example. Other examples may differ from what is described with respect to FIG. 6.

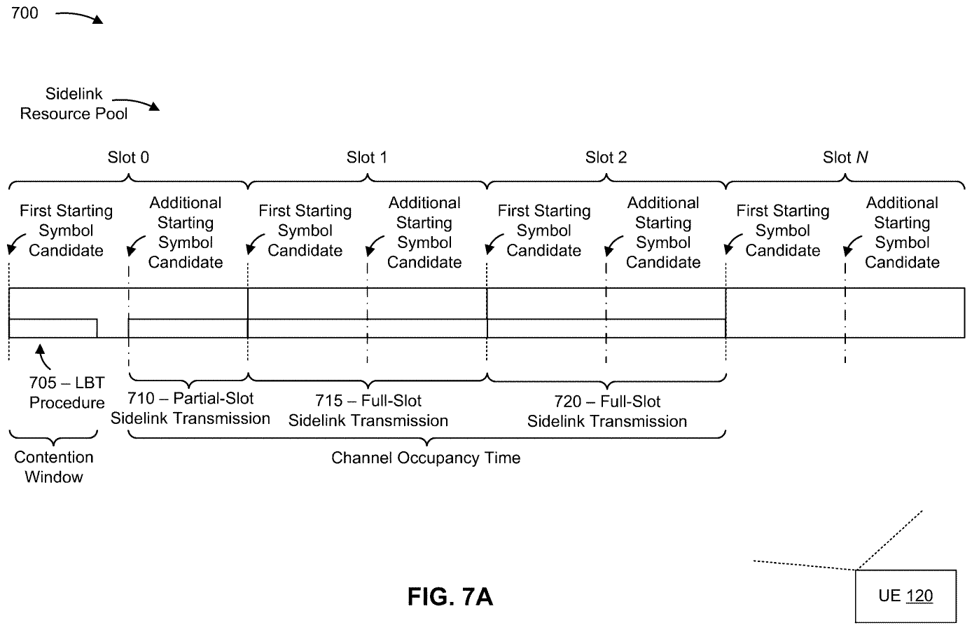

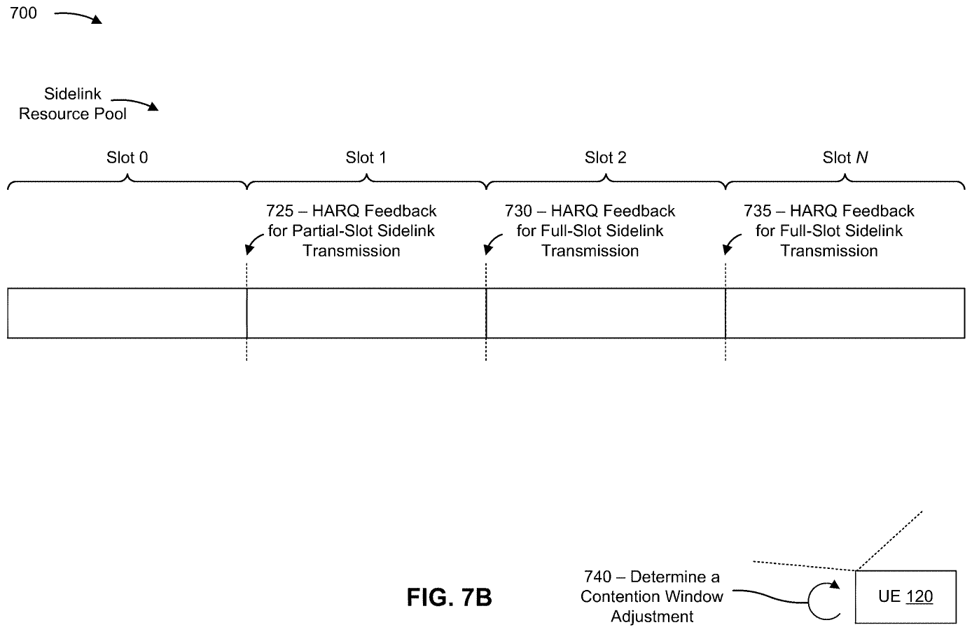

FIGS. 7A and 7B are diagrams illustrating an example 700 of contention window adjustment for sidelink communication, in accordance with the present disclosure. As shown in FIGS. 7A and 7B, the example 700 may include a UE 120 (or a UE 405, a UE 120, a Tx/Rx UE 505, and/or an Rx/Tx UE 510). The UE 120 may communicate with another UE 120 on a sidelink in a wireless network, such as the wireless network 100. The UE 120 may communicate on the sidelink in a sidelink resource pool allocated for the sidelink. The sidelink resource pool may be configured with a plurality of starting symbol candidates at which the UE 120 may initiate a sidelink transmission is association with clearing an LBT procedure.

As shown in FIG. 7A, at 705, the UE 120 may perform an LBT procedure in a contention window in one or more slots (e.g., Slot 0) in the sidelink resource pool. The UE 120 may perform the LBT procedure to obtain a channel occupancy time for transmitting one or more sidelink transmissions (e.g., to another UE 120) in the sidelink resource pool. The LBT procedure may be a category 1 (CAT-1) LBT procedure, a category 4 (CAT-4) LBT procedure, and/or another type of LBT procedure. If the UE 120 can clear the LBT procedure before the end of the contention window, the UE 120 may access the sidelink resource pool for the COT.

At 710, the UE 120 may transmit a partial-slot sidelink transmission in Slot 0 in the COT. The UE 120 may initiate or start the transmission of the partial-slot sidelink transmission at an additional starting symbol candidate in Slot 0 because of clearing the LBT procedure at a time after the occurrence of the first starting symbol candidate in Slot 0. At 715 and 720, the UE 120 may continue to transmit sidelink transmissions during the COT. For example, at 715, the UE 120 may transmit a full-slot sidelink transmission in Slot 1. As another example, at 720, the UE 120 may transmit another full-slot sidelink transmission in Slot 2. In some aspects, the partial-slot sidelink transmission at 710, the full-slot sidelink transmission at 715, and the full-slot sidelink transmission at 720 are all part of a single sidelink transmission that spans a plurality of slots. In some aspects, slot-based transmissions are supported in the sidelink resource pool; and the partial-slot sidelink transmission at 710, the full-slot sidelink transmission at 715, and the full-slot sidelink transmission at 720 may each be slot-based sidelink transmissions. The partial-slot sidelink transmission at 710, the full-slot sidelink transmission at 715, and the full-slot sidelink transmission at 720 may each include a PSSCH transmission, a PSCCH transmission, and/or another type of sidelink transmission.

As shown in FIG. 7B, the UE 120 may receive HARQ feedback for the sidelink transmissions at 710-720. The UE 120 may receive the HARQ feedback from one or more other UEs 120 to which the UE 120 transmitted the sidelink transmissions at 710-720. For example, at 725, the UE 120 may receive HARQ feedback (e.g., an acknowledgement (ACK) or a NACK) for the partial-slot sidelink transmission transmitted in Slot 0 at 710. As another example, at 730, the UE 120 may receive HARQ feedback (e.g., an ACK or a NACK) for the full-slot sidelink transmission transmitted in Slot 1 at 715. As another example, at 735, the UE 120 may receive HARQ feedback (e.g., an ACK or a NACK) for the full-slot sidelink transmission transmitted in Slot 2 at 720.

In some aspects, the UE 120 may receive the HARQ feedback for the partial-slot sidelink transmission in Slot 0 (e.g., may receive the HARQ feedback in one or more symbols reserved for the transmission and reception of HARQ feedback in Slot 0). In some aspects, the UE 120 may receive the HARQ feedback, for the partial-slot sidelink transmission, in the last symbol in Slot 0.

In some aspects, the UE 120 may receive the HARQ feedback for the full-slot sidelink transmission in Slot 1 (e.g., may receive the HARQ feedback in one or more symbols reserved for the transmission and reception of HARQ feedback in Slot 1). In some aspects, the UE 120 may receive the HARQ feedback, for the full-slot sidelink transmission, in the last symbol in Slot 1.

In some aspects, the UE 120 may receive the HARQ feedback for the full-slot sidelink transmission in Slot 2 (e.g., may receive the HARQ feedback in one or more symbols reserved for the transmission and reception of HARQ feedback in Slot 2). In some aspects, the UE 120 may receive the HARQ feedback, for the full-slot sidelink transmission, in the last symbol in Slot 2.

As another example, at 730, the UE 120 may receive HARQ feedback (e.g., an ACK or a NACK) for the full-slot sidelink transmission transmitted in Slot 1 at 715. As another example, at 735, the UE 120 may receive HARQ feedback (e.g., an ACK or a NACK) for the full-slot sidelink transmission transmitted in Slot 2 at 720.

As further shown in FIG. 7B, at 740, the UE 120 may determine a contention window adjustment for performing an LBT procedure on the sidelink. The UE 120 may increase the size of the contention window, may decrease the size of the contention window, may reset the size of the contention window to a default contention window size, and/or may maintain the size of the contention window.

The UE 120 may determine the contention window adjustment based at least in part on the HARQ feedback received for the partial-slot sidelink transmission transmitted in Slot 0 (e.g., the HARQ feedback associated with Slot 0) and/or based at least in part on the HARQ feedback received for the full-slot sidelink transmission transmitted in Slot 1 (e.g., the HARQ feedback associated with Slot 1). The UE 120 may determine whether to use the HARQ feedback received for the partial-slot sidelink transmission transmitted in Slot 0 (e.g., the HARQ feedback associated with Slot 0) and/or to use the HARQ feedback received for the full-slot sidelink transmission transmitted in Slot 1 (e.g., the HARQ feedback associated with Slot 1) based at least in part on one or more parameters. In general, since the COT spans a plurality of slots, the UE 120 may intelligently select which of the slots for which HARQ feedback is to be used to determine the contention window adjustment.

In some aspects, the UE 120 may determine to use the HARQ feedback associated with a first full-slot sidelink transmission in the COT (e.g., the HARQ feedback associated with the full-slot sidelink transmission in Slot 1) because the first full-slot sidelink transmission may be less likely to be punctured than the partial-slot sidelink transmission and/or may be more accurately encoded than the partial-slot sidelink transmission, which may reduce the likelihood of the UE 120 receiving a NACK for the first full-slot sidelink transmission. This may avoid or reduce the likelihood of the UE 120 unnecessarily increasing the size (e.g., the duration) of the contention window.

The UE 120 may use the ending symbol in the slot associated with the HARQ feedback for the first full-slot sidelink transmission in the COT (e.g., the HARQ feedback associated with the full-slot sidelink transmission in Slot 1) as an ending symbol for a contention window reference duration. Here, the UE 120 may use the ending symbol in the slot (Slot 1) as the end timing for defining the reference duration for determining the contention window adjustment.

In some aspects, the UE 120 may determine to use the HARQ feedback associated with a first full-slot sidelink transmission in the COT (e.g., the HARQ feedback associated with Slot 1) or the HARQ feedback associated with the partial-slot sidelink transmission in the COT (e.g., the HARQ feedback associated with Slot 0). The UE 120 may select the HARQ feedback associated with a first full-slot sidelink transmission in the COT or the HARQ feedback associated with the partial-slot sidelink transmission in the COT based at least in part on whether the partial-slot sidelink transmission was accurately encoded.

For example, UE 120 may select the HARQ feedback associated with a first full-slot sidelink transmission in the COT or the HARQ feedback associated with the partial-slot sidelink transmission in the COT based at least in part on a configured quantity of reference symbols that is configured for the sidelink resource pool for determining a transport block size for sidelink transmissions in the sidelink resource pool. The configured quantity of reference symbols (e.g., the nominal symbol duration) that the UE 120 uses for determining the transport block size for the sidelink transmission may be different from the actual symbol duration of the sidelink transmission. The configured quantity of reference symbols may enable the UE 120 to more quickly determine a transport block size for a sidelink transmission in the sidelink resource pool, as opposed to using the actual quantity of symbols of the sidelink transmission. Using the configured quantity of reference symbols to determine a transport block size for a sidelink transmission may reduce transmission delays for the UE 120 in that the UE 120 does not have to wait until the actual quantity of symbols for the sidelink transmission is known, which may not occur until just before the sidelink transmission is transmitted due to the availability of additional starting symbol candidates in the sidelink resource pool.

The UE 120 may determine a symbol quantity difference between the configured quantity of reference symbols and the actual quantity of symbols for the partial-slot sidelink transmission. The UE 120 may determine whether the symbol quantity difference satisfies a threshold quantity.

If the UE 120 determines that the symbol quantity difference satisfies the threshold quantity (e.g., that the symbol quantity difference is equal to the threshold quantity, that the symbol quantity difference is greater than the threshold quantity), the UE 120 may determine the contention window adjustment based at least in part on the HARQ feedback associated with the first full-slot sidelink transmission in the COT (e.g., the HARQ feedback received for Slot 1). This is because the difference between the configured quantity of reference symbols and the actual quantity of symbols for the partial-slot sidelink transmission may be too great and may result in an increased likelihood of receiving a NACK for the partial-slot sidelink transmission. The UE 120 may use the ending symbol in the slot associated with the HARQ feedback for the first full-slot sidelink transmission in the COT (e.g., the HARQ feedback associated with the full-slot sidelink transmission in Slot 1) as an ending symbol for a contention window reference duration. Here, the UE 120 may use the ending symbol in the slot (Slot 1) as the end timing for defining the reference duration for determining the contention window adjustment.

If the UE 120 determines that the symbol quantity difference does not satisfy the threshold quantity (e.g., that the symbol quantity difference is equal to the threshold quantity, that the symbol quantity difference is lesser than the threshold quantity), the UE 120 may determine the contention window adjustment based at least in part on the HARQ feedback associated with the first full-slot sidelink transmission in the COT (e.g., the HARQ feedback received for Slot 1). This is because the difference between the configured quantity of reference symbols and the actual quantity of symbols for the partial-slot sidelink transmission is small, which may enable the partial-slot sidelink transmission to be accurately encoded. The UE 120 may use the ending symbol in the slot associated with the HARQ feedback for partial-slot sidelink transmission in the COT (e.g., the HARQ feedback associated with the partial-slot sidelink transmission in Slot 0) as an ending symbol for a contention window reference duration. Here, the UE 120 may use the ending symbol in the slot (Slot 0) as the end timing for defining the reference duration for determining the contention window adjustment.

In some aspects, the UE 120 may determine to use the HARQ feedback associated with a first full-slot sidelink transmission in the COT (e.g., the HARQ feedback associated with Slot 1) and the HARQ feedback associated with the partial-slot sidelink transmission in the COT (e.g., the HARQ feedback associated with Slot 0). If the sidelink transmissions at 710-720 are slot-based transmissions, the UE 120 may be permitted to perform HARQ feedback combining (e.g., soft combining) for sidelink transmissions that are transmitted in the sidelink resource pool.

The UE 120 may increase the size of the contention window if the percentage of the NACKs received during the COT satisfies a percentage threshold (e.g., is greater than or equal to 80%, or another percentage). For example, if the UE 120 determines that the percentage of the NACKs (referred to a NACK percentage or a NACK ratio Z) received during the COT (e.g., in reference subframe k) satisfies the percentage threshold, the UE 120 may increase the size (e.g., the duration) of the contention window. In some aspects, the UE 120 may increase the size (e.g., the duration) of the contention window for every priority class p to the next higher allowed value. As another example, if the UE 120 determines that the percentage of the NACKs (e.g., the NACK percentage or the NACK ratio Z) received during the COT does not satisfy the percentage threshold, the UE 120 may maintain the size (e.g., the duration) of the contention window (e.g., may refrain from increasing the size of the contention window) or may reset the size of the contention window to a default size.

In some aspects, the UE 120 may assign or may associate weights to the HARQ feedback received in the COT for HARQ feedback combining. For example, the UE 120 may assign or may associate a first weight to the HARQ feedback received for the partial-slot sidelink transmission in Slot 0, may assign or may associate a second weight to the HARQ feedback received for the full-slot sidelink transmission in Slot 1, and so on. The UE 120 may determine the NACK percentage based at least in part on the weights assigned to the HARQ feedback. In this way, the HARQ feedback for a particular type of sidelink transmission may have an increased or decreased influence in determining the NACK percentage.

In some aspects, the UE 120 may assign or may associate the same weights (e.g., equal weights) to the HARQ feedback received for each of the slots in the COT. In some aspects, the UE 120 may assign or may associate different weights to the HARQ feedback received for two or more of the slots in the COT. The UE 120 may assign or may associate weights based at least in part on the configured quantity of reference symbols for transport block size determination in the sidelink resource pool. As indicated above, the configured quantity of reference symbols (e.g., the nominal symbol duration) that the UE 120 uses for determining the transport block size for a sidelink transmission may be different from the actual symbol duration of the sidelink transmission. The UE 120 may determine a symbol quantity difference between the configured quantity of reference symbols and the actual quantity of symbols for the partial-slot sidelink transmission. The UE 120 may assign or may associate weights to the HARQ feedback received for the partial-slot sidelink transmission in Slot 0 and to the HARQ feedback received for the first full-slot sidelink transmission in Slot 1 based at least in part on the symbol quantity difference.

In some aspects, the UE 120 may assign or may associate weights to the HARQ feedback received for the partial-slot sidelink transmission in Slot 0 and to the HARQ feedback received for the first full-slot sidelink transmission in Slot 1 based at least in part on the magnitude of the symbol quantity difference. For example, the greater the magnitude of the symbol quantity difference, the greater the weight that may be assigned to the HARQ feedback received for the first full-slot sidelink transmission in Slot 1, and the lesser the weight that may be assigned to the HARQ feedback received for the partial-slot sidelink transmission in Slot 0.

In some aspects, the UE 120 may determine whether the symbol quantity difference satisfies a threshold quantity. If the UE 120 determines that the symbol quantity difference satisfies the threshold quantity (e.g., that the symbol quantity difference is equal to the threshold quantity, that the symbol quantity difference is greater than the threshold quantity), the UE 120 may assign a greater weight to the HARQ feedback received for the first full-slot sidelink transmission in Slot 1, and may assign a lesser weight to the HARQ feedback received for the partial-slot sidelink transmission in Slot 0. If the UE 120 determines that the symbol quantity difference does not satisfy the threshold quantity (e.g., that the symbol quantity difference is equal to the threshold quantity, that the symbol quantity difference is lesser than the threshold quantity), the UE 120 may assign a lesser weight to the HARQ feedback received for the first full-slot sidelink transmission in Slot 1, and may assign a greater weight to the HARQ feedback received for the partial-slot sidelink transmission in Slot 0. In some aspects, the UE 120 determines that the symbol quantity difference does not satisfy the threshold quantity, the UE 120 may assign a weight of 0 to the HARQ feedback received for the first full-slot sidelink transmission in Slot 1 so that only the HARQ feedback received for the partial-slot sidelink transmission in Slot 0 is used for determining the contention window adjustment.

As indicated above, FIGS. 7A and 7B are provided as an example. Other examples may differ from what is described with respect to FIGS. 7A and 7B.

FIG. 8 is a diagram illustrating an example process 800 performed, for example, by a UE, in accordance with the present disclosure. Example process 800 is an example where the UE (e.g., a UE 120, a UE 405, a UE 120, a Tx/Rx UE 505, and/or an Rx/Tx UE 510) performs operations associated with determining a contention window adjustment for sidelink communication.

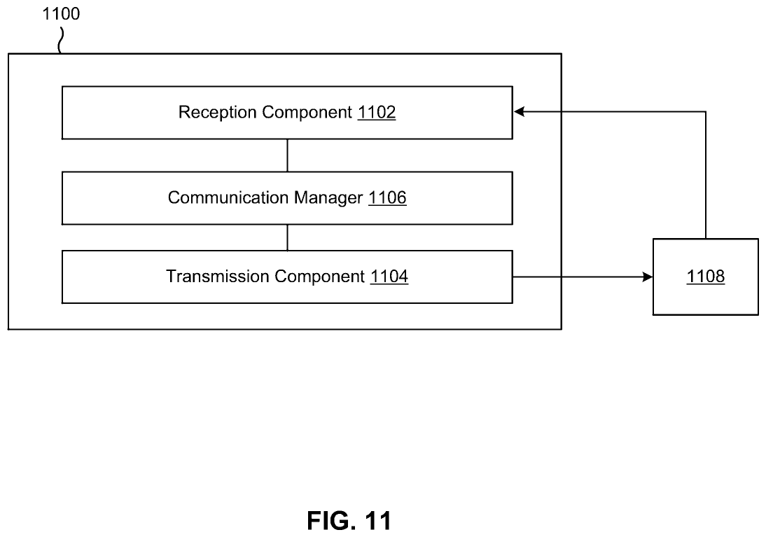

As shown in FIG. 8, in some aspects, process 800 may include transmitting, during a COT on a sidelink, a first sidelink transmission starting at a second starting symbol candidate that occurs after a first starting symbol candidate that occurs at a beginning of a first slot in the COT (block 810). For example, the UE (e.g., using transmission component 1104 and/or communication manager 1106, depicted in FIG. 11) may transmit, during a COT on a sidelink, a first sidelink transmission starting at a second starting symbol candidate that occurs after a first starting symbol candidate that occurs at a beginning of a first slot in the COT, as described above.

As further shown in FIG. 8, in some aspects, process 800 may include transmitting, during the COT on the sidelink, a second sidelink transmission that spans a duration of a second slot in the COT that occurs after the first slot (block 820). For example, the UE (e.g., using transmission component 1104 and/or communication manager 1106, depicted in FIG. 11) may transmit, during the COT on the sidelink, a second sidelink transmission that spans a duration of a second slot in the COT that occurs after the first slot, as described above.

As further shown in FIG. 8, in some aspects, process 800 may include determining a contention window adjustment based at least in part on HARQ feedback received for the second slot (block 830). For example, the UE (e.g., using communication manager 1106, depicted in FIG. 11) may determine a contention window adjustment based at least in part on HARQ feedback received for the second slot, as described above.

Process 800 may include additional aspects, such as any single aspect or any combination of aspects described below and/or in connection with one or more other processes described elsewhere herein.

In a first aspect, determining the contention window adjustment comprises identifying an end of the second slot as an end of a reference duration for the contention window adjustment, and determining the contention window adjustment based at least in part on the reference duration.

In a second aspect, alone or in combination with the first aspect, determining the contention window adjustment comprises determining the contention window adjustment based at least in part on the HARQ feedback received for the second slot and not based on HARQ feedback received for the first slot.

In a third aspect, alone or in combination with one or more of the first and second aspects, determining the contention window adjustment comprises increasing a size of a contention window for an LBT procedure on the sidelink based at least in part on a NACK ratio for the HARQ feedback for the second slot.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., a UE 120, a UE 405, a UE 120, a Tx/Rx UE 505, and/or an Rx/Tx UE 510) performs operations associated with determining a contention window adjustment for sidelink communication.

As shown in FIG. 9, in some aspects, process 900 may include transmitting, during a COT on a sidelink, a first sidelink transmission starting at a second starting symbol candidate that occurs after a first starting symbol candidate that occurs at a beginning of a first slot in the COT (block 910). For example, the UE (e.g., using transmission component 1104 and/or communication manager 1106, depicted in FIG. 11) may transmit, during a COT on a sidelink, a first sidelink transmission starting at a second starting symbol candidate that occurs after a first starting symbol candidate that occurs at a beginning of a first slot in the COT, as described above.

As further shown in FIG. 9, in some aspects, process 900 may include transmitting, during the COT on the sidelink, a second sidelink transmission that spans a duration of a second slot in the COT that occurs after the first slot (block 920). For example, the UE (e.g., using transmission component 1104 and/or communication manager 1106, depicted in FIG. 11) may transmit, during the COT on the sidelink, a second sidelink transmission that spans a duration of a second slot in the COT that occurs after the first slot, as described above.

As further shown in FIG. 9, in some aspects, process 900 may include determining a contention window adjustment based at least in part on first HARQ feedback received for the first slot or second HARQ feedback received for the second slot (block 930). For example, the UE (e.g., using communication manager 1106, depicted in FIG. 11) may determine a contention window adjustment based at least in part on first HARQ feedback received for the first slot or second HARQ feedback received for the second slot, as described above.

Process 900 may include additional aspects, such as any single aspect or any combination of aspects described below and/or in connection with one or more other processes described elsewhere herein.

In a first aspect, determining the contention window adjustment comprises determining to use the first HARQ feedback for determining the contention window adjustment, identifying, based at least in part on determining to use the first HARQ feedback, an end of the first slot as an end of a reference duration for the contention window adjustment, and determining the contention window adjustment based at least in part on the reference duration.

In a second aspect, alone or in combination with the first aspect, determining the contention window adjustment comprises determining the contention window adjustment based at least in part on the first HARQ feedback received for the first slot and not based on the second HARQ feedback received for the second slot.

In a third aspect, alone or in combination with one or more of the first and second aspects, determining the contention window adjustment comprises determining to use the second HARQ feedback for determining the contention window adjustment, identifying, based at least in part on determining to use the second HARQ feedback, an end of the second slot as a reference duration for the contention window adjustment, and determining the contention window adjustment based at least in part on the reference duration.

In a fourth aspect, alone or in combination with one or more of the first through third aspects, determining the contention window adjustment comprises determining the contention window adjustment based at least in part on the second HARQ feedback received for the second slot and not based on the first HARQ feedback received for the second slot.

In a fifth aspect, alone or in combination with one or more of the first through fourth aspects, determining a contention window adjustment comprises determining that a difference between a quantity of reference symbols used for determining a transport block size of the first sidelink transmission, and a quantity of symbols used for the first sidelink transmission, satisfies a threshold, and determining, based at least in part on determining that the difference satisfies the threshold, the contention window adjustment based at least in part on the second HARQ feedback received for the second slot.

In a sixth aspect, alone or in combination with one or more of the first through fifth aspects, determining a contention window adjustment comprises determining that a difference between a quantity of reference symbols used for determining a transport block size of the first sidelink transmission, and a quantity of symbols used for the first sidelink transmission, does not satisfy a threshold, and determining, based at least in part on determining that the difference does not satisfy the threshold, the contention window adjustment based at least in part on the first HARQ feedback received for the first slot.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE (e.g., a UE 120, a UE 405, a UE 120, a Tx/Rx UE 505, and/or an Rx/Tx UE 510), in accordance with the present disclosure. Example process 1000 is an example where the UE (e.g., UE 120) performs operations associated with determining a contention window adjustment for sidelink communication.

As shown in FIG. 10, in some aspects, process 1000 may include transmitting, during a COT on a sidelink, a first sidelink transmission starting at a second starting symbol candidate that occurs after a first starting symbol candidate that occurs at a beginning of a first slot in the COT (block 1010). For example, the UE (e.g., using transmission component 1104 and/or communication manager 1106, depicted in FIG. 11) may transmit, during a COT on a sidelink, a first sidelink transmission starting at a second starting symbol candidate that occurs after a first starting symbol candidate that occurs at a beginning of a first slot in the COT, as described above.

As further shown in FIG. 10, in some aspects, process 1000 may include transmitting, during the COT on the sidelink, a second sidelink transmission that spans a duration of a second slot in the COT that occurs after the first slot (block 1020). For example, the UE (e.g., using transmission component 1104 and/or communication manager 1106, depicted in FIG. 11) may transmit, during the COT on the sidelink, a second sidelink transmission that spans a duration of a second slot in the COT that occurs after the first slot, as described above.

As further shown in FIG. 10, in some aspects, process 1000 may include determining a contention window adjustment based at least in part on first HARQ feedback received for the first slot and second HARQ feedback received for the second slot (block 1030). For example, the UE (e.g., using communication manager 1106, depicted in FIG. 11) may determine a contention window adjustment based at least in part on: first HARQ feedback received for the first slot and second HARQ feedback received for the second slot, as described above.

Process 1000 may include additional aspects, such as any single aspect or any combination of aspects described below and/or in connection with one or more other processes described elsewhere herein.

In a first aspect, determining the contention window adjustment based at least in part on the first HARQ feedback and the second HARQ feedback comprises determining the contention window adjustment based at least in part on soft combining of the first HARQ feedback and the second HARQ feedback.

In a second aspect, alone or in combination with the first aspect, determining the contention window adjustment based at least in part on the first HARQ feedback and the second HARQ feedback comprises determining a NACK percentage for a combination of the first HARQ feedback and the second HARQ feedback, and determining whether the NACK percentage satisfies a percentage threshold.

In a third aspect, alone or in combination with one or more of the first and second aspects, determining the contention window adjustment based at least in part on the first HARQ feedback and the second HARQ feedback comprises determining that the NACK percentage satisfies the percentage threshold, and increasing, based at least in part on determining that the NACK percentage satisfies the percentage threshold, a size of a contention window for an LBT procedure on the sidelink.

In a fourth aspect, alone or in combination with one or more of the first through third aspects, determining the contention window adjustment based at least in part on the first HARQ feedback and the second HARQ feedback comprises determining that the NACK percentage does not satisfy the percentage threshold, and refraining from increasing, based at least in part on determining that the NACK percentage satisfies the percentage threshold, a size of a contention window for a LBT procedure on the sidelink.

In a fifth aspect, alone or in combination with one or more of the first through fourth aspects, determining the NACK percentage comprises determining the NACK percentage using a same weighting for the first HARQ feedback and the second HARQ feedback.

In a sixth aspect, alone or in combination with one or more of the first through fifth aspects, determining the NACK percentage comprises determining the NACK percentage using a first weighting for the first HARQ feedback and a second weighting for the second HARQ feedback.

In a seventh aspect, alone or in combination with one or more of the first through sixth aspects, process 1000 includes determining the first weighting for the first HARQ feedback based at least in part on a quantity of reference symbols that was used to determine a transport block size of the first sidelink transmission.

In an eighth aspect, alone or in combination with one or more of the first through seventh aspects, process 1000 includes determining the first weighting for the first HARQ feedback based at least in part on whether a difference between a quantity of reference symbols used for determining a transport block size of the first sidelink transmission, and a quantity of symbols used for the first sidelink transmission, satisfies a threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., a UE 120, a UE 405, a UE 120, a Tx/Rx UE 505, and/or an Rx/Tx UE 510), or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A and 7B. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some implementations, the transmission component 1104 may transmit (e.g., to the apparatus 1108), during a COT on a sidelink, a first sidelink transmission starting at a second starting symbol candidate that occurs after a first starting symbol candidate that occurs at a beginning of a first slot in the COT. The transmission component 1104 may transmit (e.g., to the apparatus 1108), during the COT on the sidelink, a second sidelink transmission that spans a duration of a second slot in the COT that occurs after the first slot. The communication manager 1106 may determine a contention window adjustment based at least in part on HARQ feedback received (e.g., from the apparatus 1108) for the second slot.

In some aspects, the transmission component 1104 may transmit (e.g., to the apparatus 1108), during a COT on a sidelink, a first sidelink transmission starting at a second starting symbol candidate that occurs after a first starting symbol candidate that occurs at a beginning of a first slot in the COT. The transmission component 1104 may transmit (e.g., to the apparatus 1108), during the COT on the sidelink, a second sidelink transmission that spans a duration of a second slot in the COT that occurs after the first slot. The communication manager 1106 may determine a contention window adjustment based at least in part on first HARQ feedback received (e.g., from the apparatus 1108) for the first slot or second HARQ feedback received (e.g., from the apparatus 1108) for the second slot.

In some aspects, the transmission component 1104 may transmit (e.g., to the apparatus 1108), during a COT on a sidelink, a first sidelink transmission starting at a second starting symbol candidate that occurs after a first starting symbol candidate that occurs at a beginning of a first slot in the COT. The transmission component 1104 may transmit (e.g., to the apparatus 1108), during the COT on the sidelink, a second sidelink transmission that spans a duration of a second slot in the COT that occurs after the first slot. The communication manager 1106 may determine a contention window adjustment based at least in part on first HARQ feedback received (e.g., from the apparatus 1108) for the first slot and second HARQ feedback received (e.g., from the apparatus 1108) for the second slot.

In some aspects, the communication manager 1106 may determine the first weighting for the first HARQ feedback based at least in part on a quantity of reference symbols that was used to determine a transport block size of the first sidelink transmission.

In some aspects, the communication manager 1106 may determine the first weighting for the first HARQ feedback based at least in part on whether a difference between a quantity of reference symbols used for determining a transport block size of the first sidelink transmission, and a quantity of symbols used for the first sidelink transmission, satisfies a threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

### Aspect 1

A method of wireless communication performed by a user equipment (UE), comprising: transmitting, during a channel occupancy time (COT) on a sidelink, a first sidelink transmission starting at a second starting symbol candidate that occurs after a first starting symbol candidate that occurs at a beginning of a first slot in the COT; transmitting, during the COT on the sidelink, a second sidelink transmission that spans a duration of a second slot in the COT that occurs after the first slot; and determining a contention window adjustment based at least in part on hybrid automatic repeat request (HARQ) feedback received for the second slot.

### Aspect 2

The method of Aspect 1, wherein determining the contention window adjustment comprises: identifying an end of the second slot as an end of a reference duration for the contention window adjustment; and determining the contention window adjustment based at least in part on the reference duration.

### Aspect 3

The method of any of Aspects 1-2, wherein determining the contention window adjustment comprises: determining the contention window adjustment based at least in part on the HARQ feedback received for the second slot and not based on HARQ feedback received for the first slot.

### Aspect 4

The method of any of Aspects 1-3, wherein determining the contention window adjustment comprises: increasing a size of a contention window for a listen before talk (LBT) procedure on the sidelink based at least in part on a negative acknowledgement (NACK) ratio for the HARQ feedback for the second slot.

### Aspect 5

A method of wireless communication performed by a user equipment (UE), comprising: transmitting, during a channel occupancy time (COT) on a sidelink, a first sidelink transmission starting at a second starting symbol candidate that occurs after a first starting symbol candidate that occurs at a beginning of a first slot in the COT; transmitting, during the COT on the sidelink, a second sidelink transmission that spans a duration of a second slot in the COT that occurs after the first slot; and determining a contention window adjustment based at least in part on: first hybrid automatic repeat request (HARQ) feedback received for the first slot, or second HARQ feedback received for the second slot.

### Aspect 6

The method of Aspect 5, wherein determining the contention window adjustment comprises: determining to use the first HARQ feedback for determining the contention window adjustment; identifying, based at least in part on determining to use the first HARQ feedback, an end of the first slot as an end of a reference duration for the contention window adjustment; and determining the contention window adjustment based at least in part on the reference duration.

### Aspect 7

The method of Aspect 6, wherein determining the contention window adjustment comprises: determining the contention window adjustment based at least in part on the first HARQ feedback received for the first slot and not based on the second HARQ feedback received for the second slot.

### Aspect 8

The method of any of Aspects 5-7, wherein determining the contention window adjustment comprises: determining to use the second HARQ feedback for determining the contention window adjustment; identifying, based at least in part on determining to use the second HARQ feedback, an end of the second slot as a reference duration for the contention window adjustment; and determining the contention window adjustment based at least in part on the reference duration.

### Aspect 9

The method of Aspect 8, wherein determining the contention window adjustment comprises: determining the contention window adjustment based at least in part on the second HARQ feedback received for the second slot and not based on the first HARQ feedback received for the second slot.

### Aspect 10

The method of any of Aspects 5-9, wherein determining a contention window adjustment comprises: determining that a difference between a quantity of reference symbols used for determining a transport block size of the first sidelink transmission, and a quantity of symbols used for the first sidelink transmission, satisfies a threshold; and determining, based at least in part on determining that the difference satisfies the threshold, the contention window adjustment based at least in part on the second HARQ feedback received for the second slot.

### Aspect 11

The method of any of Aspects 5-10, wherein determining a contention window adjustment comprises: determining that a difference between a quantity of reference symbols used for determining a transport block size of the first sidelink transmission, and a quantity of symbols used for the first sidelink transmission, does not satisfy a threshold; and determining, based at least in part on determining that the difference does not satisfy the threshold, the contention window adjustment based at least in part on the first HARQ feedback received for the first slot.

### Aspect 12

A method of wireless communication performed by a user equipment (UE), comprising: transmitting, during a channel occupancy time (COT) on a sidelink, a first sidelink transmission starting at a second starting symbol candidate that occurs after a first starting symbol candidate that occurs at a beginning of a first slot in the COT; transmitting, during the COT on the sidelink, a second sidelink transmission that spans a duration of a second slot in the COT that occurs after the first slot; and determining a contention window adjustment based at least in part on: first hybrid automatic repeat request (HARQ) feedback received for the first slot, and second HARQ feedback received for the second slot.

### Aspect 13

The method of Aspect 12, wherein determining the contention window adjustment based at least in part on the first HARQ feedback and the second HARQ feedback comprises: determining the contention window adjustment based at least in part on soft combining of the first HARQ feedback and the second HARQ feedback.

### Aspect 14

The method of any of Aspects 12-13, wherein determining the contention window adjustment based at least in part on the first HARQ feedback and the second HARQ feedback comprises: determining a negative acknowledgement (NACK) percentage for a combination of the first HARQ feedback and the second HARQ feedback; and determining whether the NACK percentage satisfies a percentage threshold.

### Aspect 15

The method of Aspect 14, wherein determining the contention window adjustment based at least in part on the first HARQ feedback and the second HARQ feedback comprises: determining that the NACK percentage satisfies the percentage threshold; and increasing, based at least in part on determining that the NACK percentage satisfies the percentage threshold, a size of a contention window for a listen before talk (LBT) procedure on the sidelink.

### Aspect 16

The method of Aspect 14-15, wherein determining the contention window adjustment based at least in part on the first HARQ feedback and the second HARQ feedback comprises: determining that the NACK percentage does not satisfy the percentage threshold; and refraining from increasing, based at least in part on determining that the NACK percentage satisfies the percentage threshold, a size of a contention window for a listen before talk (LBT) procedure on the sidelink.

### Aspect 17

The method of Aspect 14-16, wherein determining the NACK percentage comprises: determining the NACK percentage using a same weighting for the first HARQ feedback and the second HARQ feedback.

### Aspect 18

The method of Aspect 14-17, wherein determining the NACK percentage comprises: determining the NACK percentage using a first weighting for the first HARQ feedback and a second weighting for the second HARQ feedback.

### Aspect 19

The method of Aspect 18, further comprising: determining the first weighting for the first HARQ feedback based at least in part on a quantity of reference symbols that was used to determine a transport block size of the first sidelink transmission.

### Aspect 20

The method of Aspect 18-19, further comprising: determining the first weighting for the first HARQ feedback based at least in part on whether a difference between a quantity of reference symbols used for determining a transport block size of the first sidelink transmission, and a quantity of symbols used for the first sidelink transmission, satisfies a threshold.

### Aspect 21

An apparatus for wireless communication at a device, comprising a processor; memory coupled with the processor; and instructions stored in the memory and executable by the processor to cause the apparatus to perform the method of one or more of Aspects 1-20.

### Aspect 22

A device for wireless communication, comprising a memory and one or more processors coupled to the memory, the one or more processors configured to perform the method of one or more of Aspects 1-20.

### Aspect 23

An apparatus for wireless communication, comprising at least one means for performing the method of one or more of Aspects 1-20.

### Aspect 24

A non-transitory computer-readable medium storing code for wireless communication, the code comprising instructions executable by a processor to perform the method of one or more of Aspects 1-20.

### Aspect 25

A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
transmitting, during a channel occupancy time (COT) on a sidelink, a first sidelink transmission starting at a second starting symbol candidate that occurs after a first starting symbol candidate that occurs at a beginning of a first slot in the COT;
transmitting, during the COT on the sidelink, a second sidelink transmission that spans a duration of a second slot in the COT that occurs after the first slot; and
determining a contention window adjustment based at least in part on hybrid automatic repeat request (HARQ) feedback received for the second slot.

2. The method of claim 1, wherein determining the contention window adjustment comprises:
identifying an end of the second slot as an end of a reference duration for the contention window adjustment; and
determining the contention window adjustment based at least in part on the reference duration.

3.-20. (canceled)

21. A user equipment (UE) for wireless communication, comprising:
a memory; and
one or more processors, coupled to the memory, configured to:
transmit, during a channel occupancy time (COT) on a sidelink, a first sidelink transmission starting at a second starting symbol candidate that occurs after a first starting symbol candidate that occurs at a beginning of a first slot in the COT;
transmit, during the COT on the sidelink, a second sidelink transmission that spans a duration of a second slot in the COT that occurs after the first slot; and
determine a contention window adjustment based at least in part on hybrid automatic repeat request (HARQ) feedback received for the second slot.

22. The UE of claim 21, wherein the one or more processors, to determine the contention window adjustment, are configured to:
identify an end of the second slot as an end of a reference duration for the contention window adjustment; and
determine the contention window adjustment based at least in part on the reference duration.

23. The UE of claim 21, wherein the one or more processors, to determine the contention window adjustment, are configured to:
determine the contention window adjustment based at least in part on the HARQ feedback received for the second slot and not based on HARQ feedback received for the first slot.

24. The UE of claim 21, wherein the one or more processors, to determine the contention window adjustment, are configured to:
increase a size of a contention window for a listen before talk (LBT) procedure on the sidelink based at least in part on receiving a negative acknowledgement (NACK) ratio for the HARQ feedback for the second slot.

25. A UE for wireless communication, comprising:
a memory; and
one or more processors, coupled to the memory, configured to:
transmit, during a channel occupancy time (COT) on a sidelink, a first sidelink transmission starting at a second starting symbol candidate that occurs after a first starting symbol candidate that occurs at a beginning of a first slot in the COT;
transmit, during the COT on the sidelink, a second sidelink transmission that spans a duration of a second slot in the COT that occurs after the first slot; and
determine a contention window adjustment based at least in part on:
first hybrid automatic repeat request (HARQ) feedback received for the first slot, or second HARQ feedback received for the second slot.

26. The UE of claim 25, wherein the one or more processors, to determine the contention window adjustment, are configured to:
determine to use the first HARQ feedback for determining the contention window adjustment;
identify, based at least in part on determining to use the first HARQ feedback, an end of the first slot as an end of a reference duration for the contention window adjustment; and
determine the contention window adjustment based at least in part on the reference duration.

27. The UE of claim 26, wherein the one or more processors, to determine the contention window adjustment, are configured to:
determine the contention window adjustment based at least in part on the first HARQ feedback received for the first slot and not based on the second HARQ feedback received for the second slot.

28. The UE of claim 25, wherein the one or more processors, to determine the contention window adjustment, are configured to:
determine to use the second HARQ feedback for determining the contention window adjustment;
identify, based at least in part on determining to use the second HARQ feedback, an end of the second slot as a reference duration for the contention window adjustment; and
determine the contention window adjustment based at least in part on the reference duration.

29. The UE of claim 28, wherein the one or more processors, to determine the contention window adjustment, are configured to:
determine the contention window adjustment based at least in part on the second HARQ feedback received for the second slot and not based on the first HARQ feedback received for the second slot.

30. The UE of claim 25, wherein the one or more processors, to determine a contention window adjustment, are configured to:
determine that a difference between a quantity of reference symbols used for determining a transport block size of the first sidelink transmission, and a quantity of symbols used for the first sidelink transmission, satisfies a threshold; and
determine, based at least in part on determining that the difference satisfies the threshold, the contention window adjustment based at least in part on the second HARQ feedback received for the second slot.

31. The UE of claim 25, wherein the one or more processors, to determine a contention window adjustment, are configured to:
determine that a difference between a quantity of reference symbols used for determining a transport block size of the first sidelink transmission, and a quantity of symbols used for the first sidelink transmission, does not satisfy a threshold; and
determine, based at least in part on determining that the difference does not satisfy the threshold, the contention window adjustment based at least in part on the first HARQ feedback received for the first slot.

32. A UE for wireless communication, comprising:
a memory; and
one or more processors, coupled to the memory, configured to:
transmit, during a channel occupancy time (COT) on a sidelink, a first sidelink transmission starting at a second starting symbol candidate that occurs after a first starting symbol candidate that occurs at a beginning of a first slot in the COT;
transmit, during the COT on the sidelink, a second sidelink transmission that spans a duration of a second slot in the COT that occurs after the first slot; and
determine a contention window adjustment based at least in part on:
first hybrid automatic repeat request (HARQ) feedback received for the first slot, and
second HARQ feedback received for the second slot.

33. The UE of claim 32, wherein the one or more processors, to determine the contention window adjustment based at least in part on the first HARQ feedback and the second HARQ feedback, are configured to:
determine the contention window adjustment based at least in part on soft combining of the first HARQ feedback and the second HARQ feedback.

34. The UE of claim 32, wherein the one or more processors, to determine the contention window adjustment based at least in part on the first HARQ feedback and the second HARQ feedback, are configured to:
determine a negative acknowledgement (NACK) percentage for a combination of the first HARQ feedback and the second HARQ feedback; and
determine whether the NACK percentage satisfies a percentage threshold.

35. The UE of claim 34, wherein the one or more processors, to determine the contention window adjustment based at least in part on the first HARQ feedback and the second HARQ feedback, are configured to:
determine that the NACK percentage satisfies the percentage threshold; and
increase, based at least in part on determining that the NACK percentage satisfies the percentage threshold, a size of a contention window for a listen before talk (LBT) procedure on the sidelink.

36. The UE of claim 34, wherein the one or more processors, to determine the contention window adjustment based at least in part on the first HARQ feedback and the second HARQ feedback, are configured to:
determine that the NACK percentage does not satisfy the percentage threshold; and
refrain from increasing, based at least in part on determining that the NACK percentage satisfies the percentage threshold, a size of a contention window for a listen before talk (LBT) procedure on the sidelink.

37. The UE of claim 34, wherein the one or more processors, to determine the NACK percentage, are configured to:
determine the NACK percentage using a same weighting for the first HARQ feedback and the second HARQ feedback.

38. The UE of claim 34, wherein the one or more processors, to determine the NACK percentage, are configured to:
determine the NACK percentage using a first weighting for the first HARQ feedback and a second weighting for the second HARQ feedback.

39. The UE of claim 38, wherein the one or more processors are further configured to:
determine the first weighting for the first HARQ feedback based at least in part on a quantity of reference symbols that was used to determine a transport block size of the first sidelink transmission.

40. The UE of claim 38, wherein the one or more processors are further configured to:
determine the first weighting for the first HARQ feedback based at least in part on whether a difference between a quantity of reference symbols used for determining a transport block size of the first sidelink transmission, and a quantity of symbols used for the first sidelink transmission, satisfies a threshold.
